(19) United States
(12) Patent Application Publication
(10) Pub. No.: US 2007/0254199 A1
(43) Pub. Date: Nov. 1, 2007

(54) ASSEMBLY METHOD FOR ASSEMBLING PLATE-TYPE MEMBRANE ELECTRODE ASSEMBLY LAYER AND THE STRUCTURE THEREOF

(76) Inventors: HSI-MING SHU, Taipei (TW); Tsang-Ming Chang, Taipei (TW); Chun-Wei Pan, Taipei (TW); Chia-Hao Chang, Taipei (TW)

Correspondence Address: G. LINK CO., LTD., 3550 BELL ROAD, MINOOKA, IL, 60447, US

(21) Appl. No.: 11/741,027

(22) Filed: Apr. 27, 2007

(30) Foreign Application Priority Data
May 1, 2006 (TW) 095115499

(51) Int. Cl. H01M 2/08; H01M 8/10; B32B 37/00

(52) U.S. Cl. 429/35; 429/30; 429/32; 156/293

(57) ABSTRACT

The present invention discloses an assembly method for assembling plate-type membrane electrode assembly layer and the structure thereof; wherein, the assembly method includes the following steps: providing at least one membrane electrode assembly (MEA); providing a frame, in which the frame is provided with at least one first hole, and the opening area of the first hole is slightly smaller than the area of the MEA; providing a bonding sheet, in which the bonding sheet is provided with at least one second hole, and the opening area of the second hole is slightly smaller than the area of the MEA, and each second hole is corresponding to each first hole respectively; placing these MEAs into these first holes on the frame, and covering these MEAs with the bonding sheet; and, pressing the pressing areas on the bonding sheet surrounding these second holes, so the bonding sheet, these MEAs, and the frame stacked sequentially could be joined as a plate-type MEA layer, in which these pressing areas are corresponding to the outer periphery surrounding these MEAs.

### FIELD OF THE INVENTION

The present invention relates to an assembly method of membrane electrode assembly layer for fuel cell and the structure thereof, and particularly an assembly method of plate-type membrane electrode assembly layer and the structure thereof.

### BACKGROUND OF THE INVENTION

The fuel cell is a generation device for directly transforming the chemical energy stored in fuel and oxidant into electrical energy through the electrode reaction. There are numerous types of fuel cell, and with different categorization methods. If the fuel cells are categorized by the difference of electrolyte characteristics, there are five types of fuel cells with different electrolytes, such as alkaline fuel cell, phosphorous acid fuel cell, proton exchange membrane fuel cell, molten carbonate fuel cell, solid oxide fuel cell; wherein, the proton exchange membrane fuel cell further includes so-called direct methanol fuel cell, which directly employs methanol as the fuel without transforming into hydrogen first, and becomes one of the technologies with more development resources, and the application targets include the large-scale power generation plant, generator for mobile, and portable power supply, etc.

However, the conventional manufacturing process for fuel cell did not consider the production scale in mass production, and employed the hand-made production method to manufacture the fuel cell. Thus, the manufacturing process for fuel cell could not become automated and enter into mass production. Moreover, the membrane electrode assembly in fuel cell, as one of the key components, is easily subjected to drying in the production process, or easily getting curled, and having the problem of frequently deteriorated assembly quality in the assembly process caused by shaking and displacement. These problems would cause liquid leakage in the assembled fuel cell module.

Furthermore, the method should consider to provide the manufacturing process employed in the industry with at least the following two features: 1. the process should be automated, and be able to manufacture the fuel cell in mass production; and, 2. greatly improving the errors caused by human factors in the manufacturing.

Thus, in view of the obvious defects of the conventional manufacturing art for fuel cell and based on the expectation of manufacturing technology for fuel cell in the industry, the inventor of the present invention has worked hard on the improvement, and invented an assembly method for assembling plate-type membrane electrode assembly layer and the structure thereof, so as to solve the above-mentioned problems.

### SUMMARY OF THE INVENTION

The main object of the present invention is to provide an assembly method for assembling plate-type membrane electrode assembly layer, which could effectively improve the assembly quality for fuel cell, and employ the automated method to assemble and manufacture the fuel cell in mass production.

The another object of the present invention is to provide a plate-type membrane electrode assembly layer structure, which could improve the problem of membrane electrode assembly in prior art for possible drying and easy to be curled.

To this end, the present invention provides an assembly method for assembling plate-type membrane electrode assembly layer, which includes the following steps: providing at least one membrane electrode assembly; providing a frame, wherein the frame is provided with at least one first hole, and the opening area of the first hole is slightly smaller than the area of the membrane electrode assembly; providing a bonding sheet, wherein the bonding sheet is provided with at least one second hole, and the opening area of the second hole is slightly smaller than the area of the membrane electrode assembly, and each second hole is corresponding to each first hole respectively; placing these membrane electrode assemblies into these first holes on the frame, and covering with the bonding sheet on these membrane electrode assembly; and, pressing the pressing area on the bonding sheet surrounding these second holes, so that the bonding sheet, these membrane electrode assemblies and the frame stacked sequentially could be joined as a plate-type membrane electrode assembly layer, wherein these pressing areas are corresponding to the outer periphery surrounding these membrane electrode assemblies.

The assembly method according to the present invention could manufacture the structure of the plate-type membrane electrode assembly layer according to the present invention, in which the structure of the plate-type membrane electrode assembly layer comprises: a frame, wherein the frame is provided with at least one hole; at least one membrane electrode assembly corresponding to the holes and configured on the frame, in which the area of the membrane electrode assembly is slightly larger than the opening area of the hole; and, a bonding layer, which is covered on these membrane electrode assemblies, and pressed on the frame at the outer periphery of these membrane electrode assemblies.

### BRIEF DESCRIPTION OF DRAWINGS

The purpose and the effects of the present invention may be best understood by those skilled in the art by referring to the following detailed description of the preferred embodiments and the accompanying drawings, wherein:

FIG. 1A is a three-dimensional exploded view of the structure of the plate-type membrane electrode assembly layer for the first embodiment according to the present invention;

FIG. 1B is a cross-sectional view of the structure of the plate-type membrane electrode assembly layer in FIG. 1A after pressing;

FIG. 2 is a flow chart of the assembly method for the plate-type membrane electrode assembly layer in FIG. 1A;

FIG. 3A is a three-dimensional exploded view of the structure of the plate-type membrane electrode assembly layer for the second embodiment according to the present invention;

FIG. 3B is a cross-sectional view of the structure of the plate-type membrane electrode assembly layer in FIG. 3A after pressing; and

FIG. 4 is a flow chart of the assembly method for the plate-type membrane electrode assembly layer in FIG. 3A.

### DETAILED DESCRIPTION OF THE INVENTION

The structure of plate-type membrane electrode assembly layer 1 according to the present invention is made by tightly bonding the membrane electrode assemblies 12 on the frame 10. The present invention is focused on the assembly structure of the membrane electrode assemblies 12 and the frame 10. As for the other portions composing the fuel cell, such as fuel cell channel, fuel storage tank, etc., they are not the focal points of the present invention, so they will not be described in details.

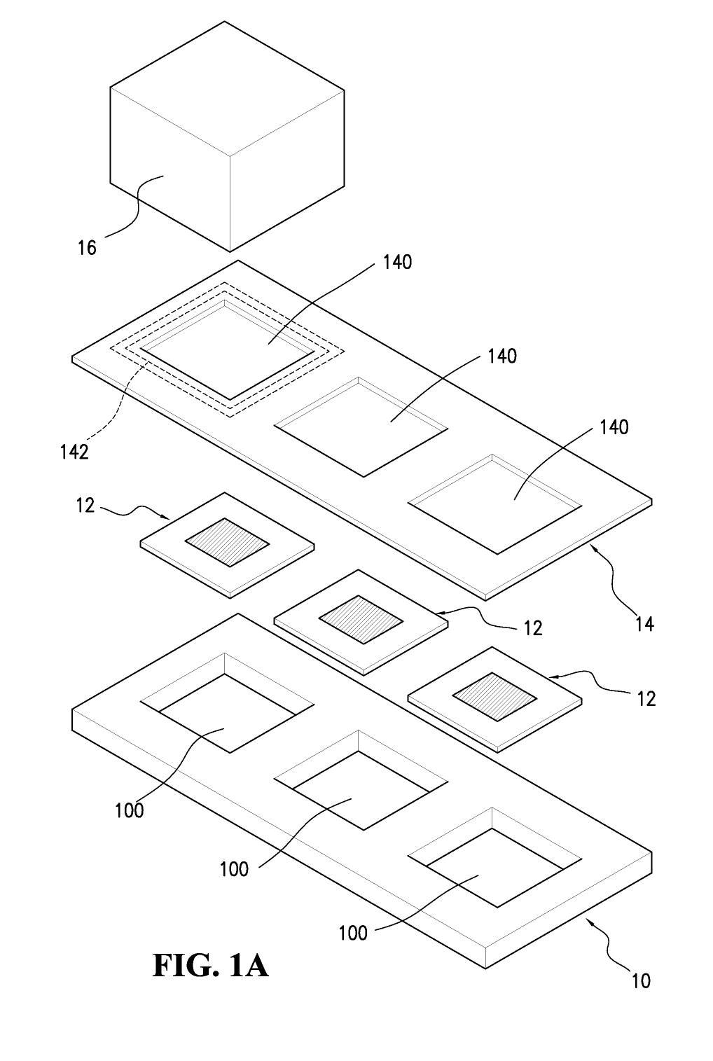

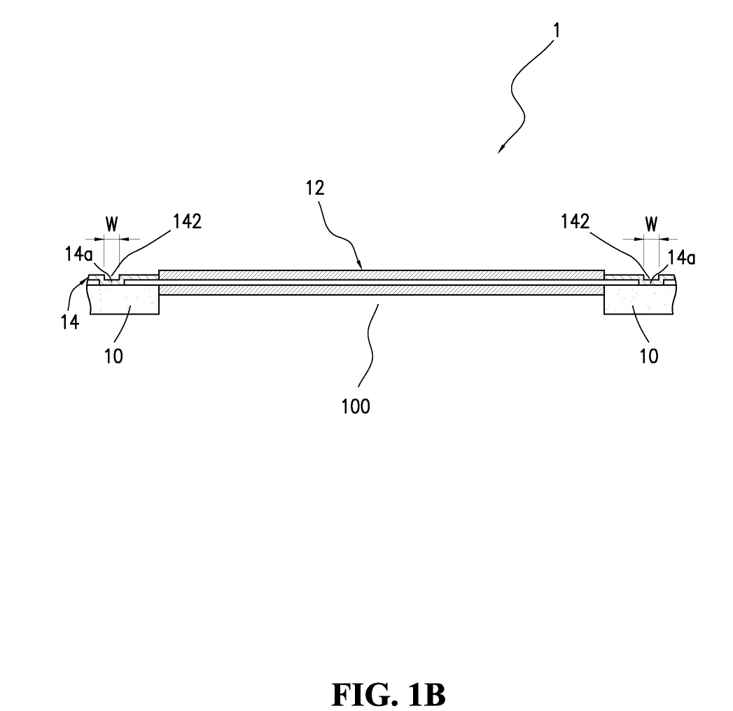

FIG. 1A is a three-dimensional exploded view of the structure of plate-type membrane electrode assembly for the first embodiment according to the present invention. FIG. 1B is a cross-sectional view of the structure of plate-type membrane electrode assembly layer in FIG. 1A after pressing. As shown in FIGS. 1A and 1B, the structure of plate-type membrane assembly layer 1 according to the present invention comprises: a frame 10, which is provided with at least one first hole 100, and the frame 10 could be used as anode electrode board or cathode electrode board in fuel cell, or only as a substrate of printed circuit board, such as FR4 substrate, flexible circuit board, etc., depending on the fuel cell structure designed by the manufacturer.

At least one membrane electrode assembly 12, which is corresponding to the first hole 100 respectively, and configured on the frame 10; wherein, the area of the membrane electrode assembly 12 is slightly larger than the opening area of the first hole 100, and the membrane electrode assembly 12 could be the membrane electrode assembly used in direct methanol fuel cell.

A bonding sheet 14 is covered on these membrane electrode assemblies 12, and the bonding layer 14a is pressed on the frame 10 at the outer periphery surrounding anode and cathode (shown as shaded area in FIG. 1A) of the membrane electrode assembly 12; wherein, the bonding layers 14a, after pressing the pressing areas 142 on the bonding sheet 14 surrounding these second holes 140 in FIG. 1A, are formed on the frame 10 at the outer periphery surrounding these membrane electrode assemblies 12; wherein, these pressing areas 142 are corresponding to the outer periphery surrounding these membrane electrode assemblies 12. Moreover, the bonding sheet 14 suitable for the present invention could employ the Prepreg resin sheet.

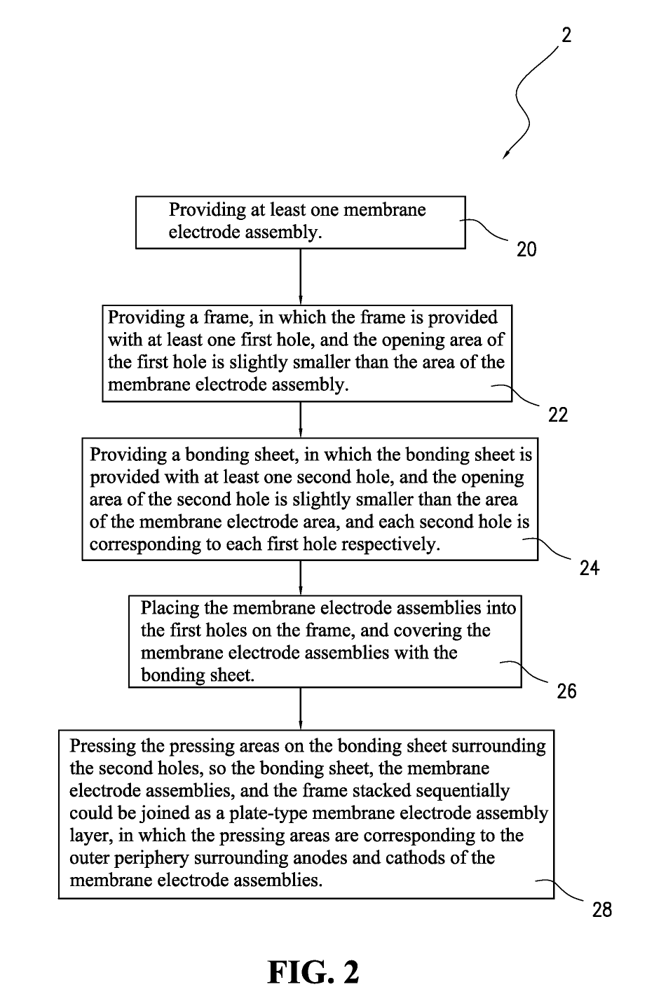

FIG. 2 is a flow chart of the assembly method for the plate-type membrane electrode assembly layer in FIG. 1A. The assembly method 2 according to the present invention includes the step 20, step 22, step 24, step 26, and step 28, which are described as follows. Step 20 is to provide at least one membrane electrode assembly 12. Step 22 is to provide a frame 10, in which the frame 10 is provided with at least one first hole 100, and the opening area of the first hole 100 is slightly smaller than the area of the membrane electrode assembly 12. Step 24 is to provide a bonding sheet 14, in which the bonding sheet 14 is provided with at least one second hole 140, and the opening area of the second hole 140 is slightly smaller than the area of the membrane electrode assembly 12, and each second hole 140 is corresponding to each first hole 100 respectively. Step 26 is to place these membrane electrode assemblies 12 into these first holes 100 on the frame 10, and covering these membrane electrode assemblies 12 with the bonding sheet 14.

Next, Step 28 is to press these pressing areas 142 on the bonding sheet 14 surrounding these second holes 140, so the bonding sheet 14, these membrane electrode assemblies 12, and the frame 10 stacked sequentially could be joined as a plate-type membrane electrode assembly layer 1, in which these pressing areas 142 are corresponding to the outer periphery surrounding these membrane electrode assemblies 12. Furthermore, the step of pressing could employ the thermal press machine 16 to apply hot pressing on these pressing areas 142 on the bonding sheet 14. The width W of these pressing areas 142 is between 1 mm to 5 mm, or larger than 0 mm and smaller than 1 mm.

The pressing areas 142 defined on the second holes 140 have the positions near the opening edge of the second hole 140, but not overlapped with anodes and cathodes of the membrane electrode assemblies 12 on the lower level, that is, the pressing force applied on the pressing areas 142 would not be transferred to the anodes and cathodes of the membrane electrode assemblies 12.

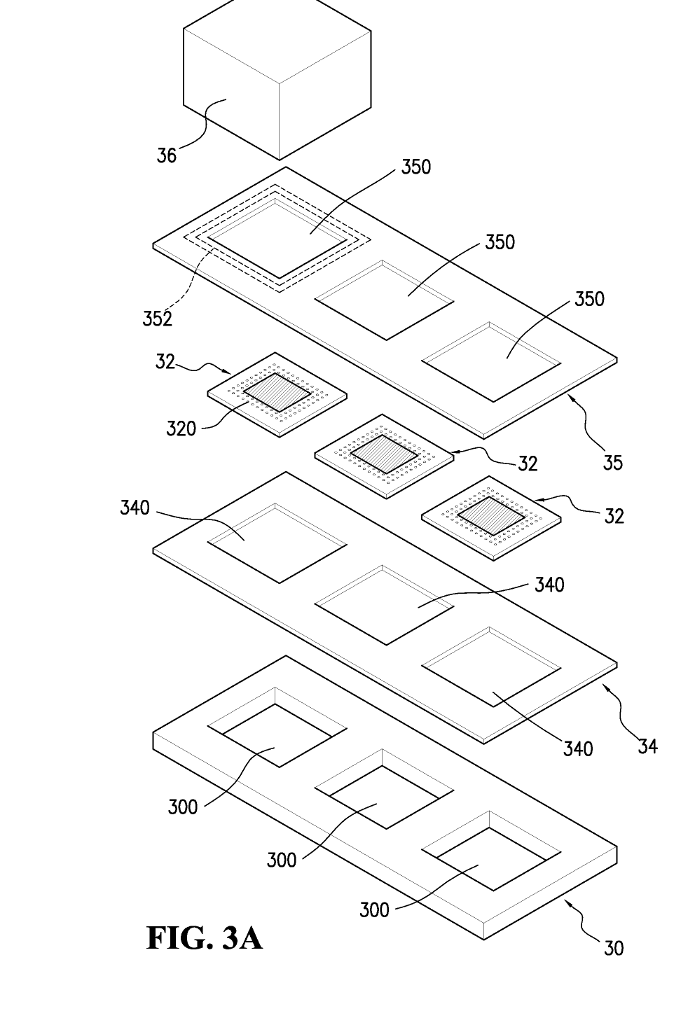

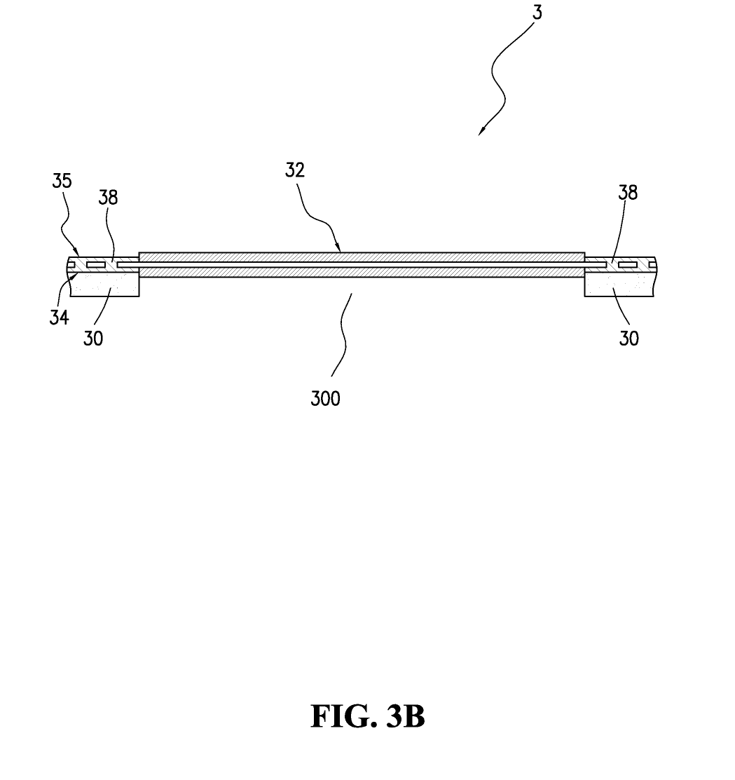

FIG. 3A is a three-dimensional exploded view of the plate-type membrane electrode assembly layer for the second embodiment according to the present invention. FIG. 3B is a cross-sectional view of the plate-type membrane electrode assembly layer in FIG. 3A after pressing. As shown in FIGS. 3A and 3B, the structure of the plate-type membrane electrode assembly layer 3 according to the present invention comprises: a frame 30, which is provided with at least one first hole 300, and the frame 30 could be used as anode electrode board or cathode electrode board in fuel cell, or only as a substrate of printed circuit board, such as FR4 substrate, flexible circuit board, etc., depending on the fuel cell structure designed by the manufacture.

At least one membrane electrode assembly 32, which is corresponding to the first hole 300 and configured on the frame 30, in which the area of the membrane electrode assembly 32 is slightly larger than the opening area of the first hole 300, and the edge area of anode and cathode (shown as shaded area in FIG. 3A) the membrane electrode assembly 32 is provides with at least one through hole 320. And, the membrane electrode assembly 32 could be a membrane electrode assembly used in direct methanol fuel cell.

A bonding layer 38, which is pressed on the edge area of these membrane electrode areas 32, and the bonding layer 38 is passing through these through-holes 320 at the edge area and pressed on the frame 30; wherein, the bonding layer 38 is pressed at the pressing area 352 on the second bonding sheet 35 surrounding these third holes 350 in FIG. 3A, and part of the material of the second bonding sheet 35 would permeate into the through holes 320, and part of the material of the first bonding sheet 34 would also permeate into the through holes 320; then, the first bonding sheet 34 and the second bonding sheet 35 would be bonded together to form bonding layers 38. Moreover, the first and second bonding sheets 34, 35 suitable for the present invention could also employ the Prepreg resin sheet, AB glue, with anti-erosion and/or anti-acid properties.

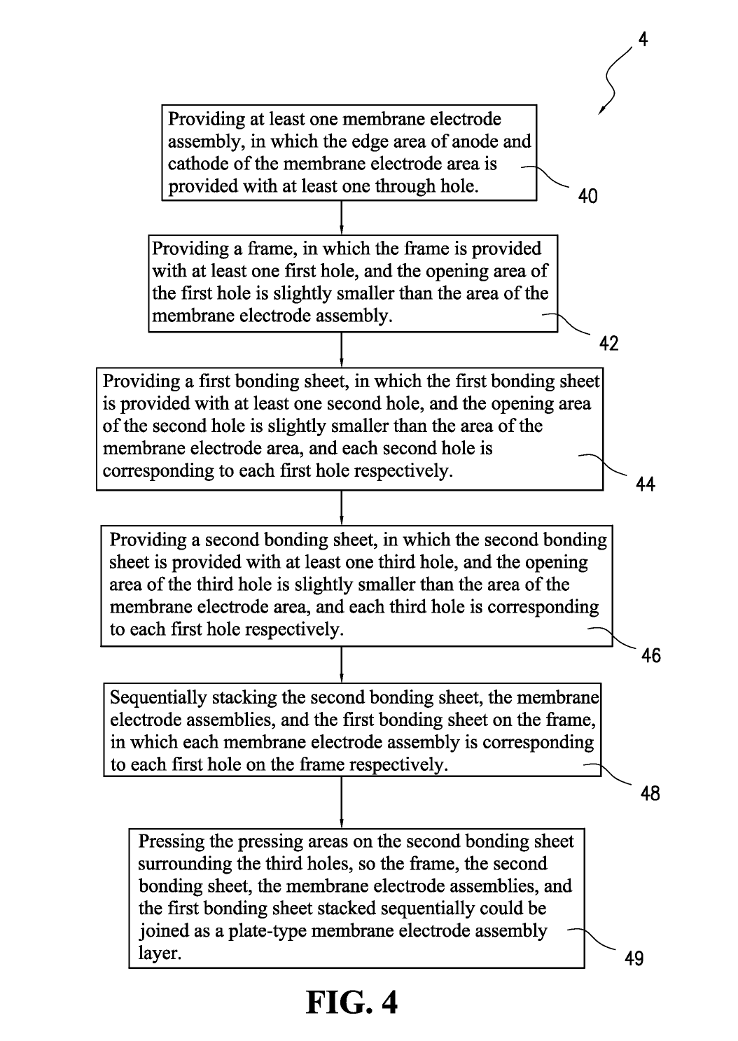

FIG. 4 is a flow chart of the assembly method for the plate-type membrane electrode assembly layer in FIG. 3A. The assembly method 4 according to the present invention includes the step 40, step 42, step 44, step 46, step 48 and step 49, which are described as follows. Step 40 is to provide at least one membrane electrode assembly 32, in which the edge area of anode and cathode of the membrane electrode assembly 32 is provided with at least one through hole 320. Step 42 is to provide a frame 30, in which the frame 30 is provided with at least one first hole 300, and the opening area of the first hole 300 is slightly smaller than the area of the membrane electrode assembly 32. Step 44 is to provide a first bonding sheet 34, in which the first bonding sheet 34 is provided with at least one second hole 340, and the opening area of the second hole 340 is slightly smaller than the area of the membrane electrode assembly 32, and each second hole 340 is corresponding to each first hole 300 respectively. Step 46 is to provide a second bonding sheet 35, in which the second bonding sheet 35 is provided with at least one third hole 350, and the opening area of the third hole 350 is slightly smaller than the area of the membrane electrode assembly 32, and each third hole 350 is corresponding to each first hole 300 respectively.

Next, Step 48 is to sequentially stack the second bonding sheet 35, these membrane electrode assemblies 32 and the first bonding sheet 34 on the frame 30, in which each membrane electrode assembly 32 is corresponding to each first hole 300 on the frame 30 respectively. Then, Step 49 is to press these pressing areas 352 on the second bonding sheet 35 surrounding these third holes 350, so the frame 30, the first bonding sheet 34, these membrane electrode assemblies 32, and the second bonding sheet 35 stacked sequentially could be joined as a plate-type membrane electrode assembly layer, in which these pressing areas 352 are corresponding to these edge areas of the anodes and cathodes of these membrane electrode assemblies 32.

These above-mentioned steps applying the pressing could employ the thermal press machine 36 to apply the hot press on these pressing areas 352 on the second bonding sheet 35. Because the first and second bonding sheets 34, 35 employ a solid bonding agent, when the temperature is reached a melting temperature, the upper and lower layers of solid bonding agent would be melted, and permeate into the through holes 320. After the cooling of solid bonding agent, the membrane electrode assembly 32 would be tightly attached on the frame 30, and finally forming the structure of plate-type membrane electrode assembly layer 3 according to the present invention.

The assembly method provided for assembling plate-type membrane electrode assembly layer and the structure thereof according to the present invention could achieve the following effects:

1. The assembly method and assembly structure according to the present invention could employ the thermal press machine for one-time press forming, without the manual assembly method, so as to achieve the automation and mass production purpose, and also substantially improve the assembly quality for fuel cell. Moreover, the present invention could also overcome the conventional problems for the membrane electrode assembly of easy drying and curling in the prior art; and
2. The assembly structure according to the present invention could employ the Prepreg resin sheet. Because this type of sheet has the properties of light and thin, the fuel cell with the assembly structure according to the present invention could also have the properties of light and thin, which is beneficial to be applied in portable electric products.

The present invention has been described as above. Thus, the disclosed embodiments are not limiting the scope of the present invention. And, for the skilled in the art, it is well appreciated that the change and modification without departing from the claims of the present invention should be within the spirit and scope of the present invention, and the protection scope of the present invention should be defined with the attached claims.

What is claimed is:

1. An assembly method for assembling plate-type membrane electrode assembly layer, comprises the following steps:
providing at least one membrane electrode assembly;
providing a frame, in which the frame is provided with at least one first hole, and the opening area of the first hole is slightly smaller than the area of the membrane electrode assembly;
providing a bonding sheet, in which the bonding sheet is provided with at least one second hole, and the opening area of the second hole is slightly smaller than the area of the membrane electrode area, and each second hole is corresponding to each first hole respectively, wherein the bonding sheet having at least one pressing area which is surrounding the second hole;
placing these membrane electrode assemblies into the first holes on the frame, and covering these membrane electrode assemblies with the bonding sheet; and,
pressing the pressing areas, so the bonding sheet, the membrane electrode assemblies, and the frame stacked sequentially could be joined as a plate-type membrane electrode assembly layer, in which the pressing areas are corresponding to the outer periphery surrounding anodes and cathodes of the membrane electrode assemblies.

2. The assembly method according to claim 1, wherein the step for applying pressing is to employ a thermal press machine to apply the hot pressing on the pressing areas, and the width of the pressing areas is between 1 mm and 5 mm.

3. The assembly method according to claim 1, wherein the step for applying pressing is to employ a thermal press machine to apply the hot pressing on the pressing areas, and the width of these pressing areas is larger than 0 mm and smaller than 1 mm.

4. The assembly method according to claim 1, wherein the membrane electrode assembly is a membrane electrode assembly for direct methanol fuel cell.

5. The assembly method according to claim 1, wherein the frame is an anode electrode board.

6. The assembly method according to claim 1, wherein the frame is a cathode electrode board.

7. The assembly method according to claim 1, wherein the bonding sheet is a Prepreg resin sheet.

8. A structure of plate-type membrane electrode assembly layer, which comprises:
a frame, in which the frame is provided with at least one first hole;
at least one membrane electrode assembly, which is corresponding to the first hole and configured on the frame, in which the area of the membrane electrode assembly is slightly larger than the opening area of the first hole;
a bonding layer, which is covered on the membrane electrode assemblies, and pressed on the frame on the outer periphery surrounding anodes and cathodes the membrane electrode assemblies.

9. The structure of plate-type membrane electrode assembly layer according to claim 8, wherein the membrane electrode assembly is a membrane electrode assembly for direct methanol fuel cell.

10. The structure of plate-type membrane electrode assembly layer according to claim 8, wherein the frame is an anode electrode board.

11. The structure of plate-type membrane electrode assembly layer according to claim 8, wherein the frame is a cathode electrode board.

12. The structure of plate-type membrane electrode assembly layer according to claim 8, wherein the bonding layer is a Prepreg resin sheet.

13. An assembly method for assembling plate-type membrane electrode assembly layer, comprises the following steps:
providing at least one membrane electrode assembly, in which the edge area of anode and cathode of the membrane electrode assembly is provided with at least one through hole;
providing a frame, in which the frame is provided with at least one first hole, and the opening area of the first hole is slightly smaller than the area of the membrane electrode assembly;
providing a first bonding sheet, in which the first bonding sheet is provided with at least one second hole, and the opening area of the second hole is slightly smaller than the area of the membrane electrode area, and each second hole is corresponding to each first hole respectively;
providing a second bonding sheet, in which the second bonding sheet is provided with at least one third hole, and the opening area of the third hole is slightly smaller than the area of the membrane electrode assembly, and each third hole is corresponding to each first hole respectively, wherein the second bonding sheet having at least one pressing area surrounding the third hole;
sequentially from top to bottom stacking the second bonding sheet, the membrane electrode assemblies, and the first bonding sheet on the frame, in which each membrane electrode assembly is corresponding to each first hole on the frame respectively; and,
pressing the pressing areas, so the frame, the first bonding sheet, the membrane electrode assemblies, and the second bonding sheet stacked sequentially could be joined as a plate-type membrane electrode assembly layer, in which the pressing areas are corresponding to the edge area of the membrane electrode assemblies.

14. The assembly method according to claim 13, wherein the membrane electrode assembly is a membrane electrode assembly for direct methanol fuel cell.

15. The assembly method according to claim 13, wherein the frame is an anode electrode board.

16. The assembly method according to claim 13, wherein the frame is a cathode electrode board.

17. The assembly method according to claim 13, wherein the first bonding sheet is a Prepreg resin sheet.

18. The assembly method according to claim 13, wherein the second bonding sheet is a Prepreg resin sheet.

19. A structure of plate-type membrane electrode assembly layer, which comprises:
a frame, in which the frame is provided with at least one first hole;
at least one membrane electrode assembly, which is corresponding to the first hole and configured on the frame, in which the area of the membrane electrode assembly is slightly larger than the opening area of the first hole, and the edge area of anode and cathode of the membrane electrode assembly is provided with at least one through hole;
a bonding layer, which is pressed at the edge areas of the anodes and cathodes of the membrane electrode assemblies, and the bonding layer is passing these through holes at the edge areas and pressed on the frame.

20. The structure of plate-type membrane electrode assembly layer according to claim 19, wherein the membrane electrode assembly is a membrane electrode assembly for direct methanol fuel cell.

21. The structure of plate-type membrane electrode assembly layer according to claim 19, wherein the frame is an anode electrode board.

22. The structure of plate-type membrane electrode assembly layer according to claim 19, wherein the frame is a cathode electrode board.

23. The structure of plate-type membrane electrode assembly layer according to claim 19, wherein the bonding layer is made of anti-erosion and/or anti-acid material.

24. The structure of plate-type membrane electrode assembly layer according to claim 23, wherein the anti-erosion and/or anti-acid material is a Prepreg resin sheet.

25. The structure of plate-type membrane electrode assembly layer according to claim 23, wherein the anti-erosion and/or anti-acid material is an AB glue.
